(19) United States
(12) Patent Application Publication
(10) Pub. No.: US 2008/0104996 A1
(43) Pub. Date: May 8, 2008

(54) Molding die, intermediate member, and method of manufacturing of substrate

(75) Inventor: Hiroshi Minazawa, Nagano (JP)

Correspondence Address: RABIN & Berdo, PC, 1101 14TH STREET, NW, SUITE 500, WASHINGTON, DC, 20005, US

(73) Assignee: Fuji Electric Device Technology Co., Ltd, Tokyo (JP)

(21) Appl. No.: 11/898,349

(22) Filed: Sep. 11, 2007

(30) Foreign Application Priority Data
Oct. 25, 2006 (JP) 2006-289896

(51) Int. Cl. C03B 11/08

(52) U.S. Cl. 65/66; 249/117; 249/160; 65/166

(57) ABSTRACT

A molding die, intermediate member, and method of manufacturing a substrate are provided in which intrusion of air between the substrate molding material and the molding die during molding is suppressed, and release of the substrate molding material from the press molding die after the molding process is made easy even in the center of the molding die. A molding die for molding an intermediate member has a disk area molding portion which molds a disk area, and a removal area molding portion which molds a removal area, the removal area molding portion including a curved surface portion which is continuously concave. An intermediate member manufactured using the molding die has a disk area and a removal area which has a curved surface portion which is continuously convex and which becomes an aperture portion upon removal.

### BACKGROUND OF THE INVENTION

1. Field of the Invention

This invention relates to a molding die for manufacturing a substrate for an information recording medium to be installed in various magnetic recording devices in use, such as an external storage device for a computer, as well as to an intermediate member manufactured using such a molding die, and to a method of manufacturing a substrate for an information recording medium from the intermediate member.

2. Description of the Related Art

In magnetic disk devices of the prior art, aluminum (Al) has typically been used as the substrate material of magnetic disks. Disks formed by covering these substrates with a nickel (Ni)-phosphorus (P) plated layer have been employed. However, because magnetic disk substrate materials are currently required to have shock-resistance properties, there has been a mounting demand for glass substrates, which are highly rigid and not easily deformed even during high-speed rotation, and which have high smoothness. In particular, there is an increasing demand for glass substrates primarily for use in magnetic disk devices for mobile applications.

On the other hand, in the past, magnetic disk devices have been employed in information products for home use and there has been a need to secure supply volumes to match the large demand for glass substrates. Moreover, there are demands for further reductions in the cost of glass substrates. In order to satisfy these demands, glass substrates are mass-produced using press molding. In press molding of glass substrates, first the glass material is heated to close to the softening point, and pressure is applied using a die to mold the material. Then the glass substrate is cooled in a cooling process. During this cooling process, because of the difference in thermal expansion coefficients of the glass material and the die used in press molding, the glass material is easily released from the die for press molding. By this means, the glass substrate is released from the die for press molding, and a glass substrate molded to the desired shape is obtained.

However, when a die for press molding is used in press molding of glass material into a thin plate shape, because of the large relative position shift between the glass and the die at the outer periphery of the glass material during thermal contraction, the glass is easily released from the press molding die. On the other hand, at the center of the glass material, the difference in thermal contraction between the glass material and the press molding die is small. Hence at the center of the glass material, an adequate release effect cannot be obtained upon release. Further, when press molding into a thin plate shape with a large deformation rate, an extremely high pressing pressure is applied to the glass material, and so at the center, where an adequate release effect is not obtained, there is the possibility that the die surface and the heating-softened glass material may enter a state of tight adhesion. Hence release of the glass material from the surface of the die for press molding becomes difficult, and not only does the material tend to adhere, but upon release there is concern that the glass material may be cracked.

In order to avoid such problems, in Japanese Patent Laid-open No. 2003-26431, a die surface shape is disclosed in which, by providing such elements as a step portion, groove, and rough area with surface roughness in the surface shape of the press molding die, release of the glass material from the press molding die is promoted. However, for the configuration disclosed in Japanese Patent Laid-open No. 2003-26431, when thermal contraction of the glass material occurs in the cooling process after press molding, a step portion or similar is formed on the inside of the die in order to impede thermal contraction, and so there is the possibility that on the periphery of the step portion or similar of the glass material a portion of the glass material may thermally contract while being constrained on the inside of the die. Hence there is concern that tensile stress may occur in the interior of the glass material. If tensile stress occurs in the interior of the glass material, the glass may crack easily, and there is the possibility that the shape proposed in Japanese Patent Laid-open No. 2003-26431 may induce glass cracking.

In Japanese Patent Laid-open No. 2002-338.275, a press molding method is disclosed which employs a first die member, having a horizontal press molding surface, and a second die member, having a press molding surface with a shape having a tapered surface such that as a result of molding the glass material becomes thinner in moving from the center toward the periphery. In the case of this method, the thickness of the press molded glass substrate becomes thinner in moving from the center toward the outside, so that within the component in the direction of contraction of the glass material due to thermal contraction there exists a component in the direction of release of the glass material from the press molding die. Hence as the glass material contracts, there is also contraction in the direction causing the glass material to be released from the die for press molding. As a result, mold release of the glass material from the press molding die becomes easy. However, the press molding surface of the second die member has a tapered shape, and so this surface cannot be used as a substrate, and such substrates are limited to applications with special shapes.

In Japanese Patent Laid-open No. 2003-81650, a method for press molding of glass material is disclosed to manufacture a substrate press molded from glass material by a press molding die comprising a first die member and a second die member; the molding surface of the first die member is formed with a horizontal molding surface to mold the substrate, and a concave portion to form a step portion is provided in the molding surface of the second die member. In the die for press molding used in this press molding method, the bottom-side edge portion of the concave portion of the second die member has a radius of curvature R which is larger than the radius of curvature r of the glass material stipulated based on the wetting angle of the glass material with the second die member. By this means, at the time of press molding, air does not intrude between the glass material and the bottom-side member, and the occurrence of air pockets within the glass member is suppressed.

In Japanese Patent Laid-open No. 2004-71004, the removal area equivalent to a center hole in a substrate obtained by molding glass material is formed to be a thick portion, while the disk area which functions as the recording media is made thin. By making the removed portion of the substrate obtained by molding glass material a thick portion, and by making the outer periphery of the thick portion thin, when the glass material is cooled in the cooling process after molding, the degree of advance of cooling is different in these areas. Hence the degree of contraction is different in the thick portion and in the outer periphery thereof, and so tensile stress occurs between the thin portion and the thick portion, and cracks ultimately occur therein. When cracks occur, the thick portion can easily be removed from the substrate as a result. However, the thick portion described herein has a substantially cylindrical shape, and so during molding there is the possibility that air may intrude between the glass material and the die. Further, in order to cause cracks to occur between the thick portion and the thin portion, after molding the glass material is rapidly cooled; but if the glass material is rapidly cooled then stresses occur in the interior of the disk area of the substrate, and there is the possibility that undulations in the surface may occur. Hence there may be a need for planarization treatment after press molding.

This invention was devised in light of the above-described circumstances, and has as an object the provision of a molding die, intermediate member, and method of manufacturing a substrate, in which the intrusion of air bubbles between the substrate formation material and the molding die during molding is suppressed, and which facilitates release of the substrate molding material and the press molding die even in the center portion of the molding die after the molding process.

### SUMMARY OF THE INVENTION

A molding die of this invention is a molding die for an intermediate member used to manufacture a substrate having an aperture portion and a disk area, and is characterized in that the intermediate member has a disk area and a removal area which, by being removed, becomes the aperture portion; the molding die has a disk area molding portion which molds the disk area, and a removal area molding portion which molds the removal area; and the removal area molding portion comprises a curved surface portion which is continuously concave.

By means of a molding die of this invention, because the removal area molding portion comprises a curved surface portion which is continuously concave, when the substrate molding material is molded, an intermediate member is manufactured in which a removal area comprising a curved surface portion which is continuously convex is formed. Hence when causing the intermediate member to be released after molding of the substrate molding material, by cooling the removal area of the intermediate member, the intermediate member undergoes thermal contraction in a direction having a component in the direction of release from the molding die. Further, even when the thermal contraction due to the cooling process is small, releasing action throughout the entire molding surface of the molding die can easily be obtained. Further, air does not easily intrude between the molding die and the substrate molding material.

Further, an intermediate member of this invention is an intermediate member used to manufacture a substrate having an aperture portion and a disk area, and is characterized in having a disk area and a removal area which, by being removed, becomes the aperture portion, and in that the removal area comprises a curved surface portion which is continuously convex.

By means of an intermediate member of this invention, because the removal area comprises a continuous convex surface portion, when releasing the intermediate member after the substrate molding material has been molded, by cooling the removal area of the intermediate member, the intermediate member undergoes thermal contraction in a direction having a component in the direction of release from the molding die. Further, even when the thermal contraction due to the cooling process is small, releasing action throughout the entire molding surface of the molding die can easily be obtained. Further, air does not easily intrude between the molding die and the substrate molding material.

Further, a method of manufacturing a substrate of this invention is characterized in having a step of manufacturing the above intermediate member by using the above molding die to mold substrate molding material, and a step of forming an aperture portion by removing the removal area from the intermediate member.

By means of a method of substrate manufacture of this invention, an intermediate member having a removal area comprising a curved surface portion which is continuously convex is manufactured using a molding die having a removal area molding portion comprising a continuous concave surface portion, so that when causing the intermediate member to be released after molding of the substrate molding material, by cooling the removal area of the intermediate member, the intermediate member undergoes thermal contraction in a direction having a component in the direction of release from the molding die. Moreover, even for a small amount of thermal contraction, releasing action is easily obtained across the entire molding surface of the molding die. Further, when molding the substrate molding material to manufacture the intermediate member, air does not readily intrude between the substrate molding material and the molding die, and so the occurrence of flawed items due to the intrusion of air bubbles into the substrate after molding can be suppressed and a more uniform intermediate member is obtained.

Further, it is preferable that the curved surface portion which is continuously concave in the removal area molding portion of the molding die be a spherical surface. If the continuously concave surface portion is a spherical surface, then manufacture of the molding die is facilitated.

Further, it is preferable that the thermal expansion coefficient of the material constituting the molding die be smaller than the thermal expansion coefficient of the substrate molding material. By this means, when releasing the substrate molding material from the molding die, the direction of thermal contraction of the substrate molding material is reliably directed in the direction of release from the molding die so that uniform release of the intermediate member is facilitated.

Further, when the concave surface portion of the removal area molding portion of the molding die is formed from a spherical surface, it is preferable that the shape of the substrate molding material when positioned on the molding die prior to the molding process be a spherical shape, and that the radius of curvature of the substrate molding material prior to molding be smaller than the radius of curvature of the concave surface portion. By this means, air bubbles do not readily intrude between the molding die and the substrate molding material.

By means of a molding die of this invention, when releasing an intermediate member from the molding die, thermal contraction occurs in a direction having a component in the direction of release of the intermediate member from the molding die, and even when the amount of thermal contraction in the cooling process is small, a releasing action is easily obtained across the entire molding surface of the molding die, so that release is facilitated. Hence adhesion of the substrate molding material to the molding die in manufacturing processes, and the occurrence of flawed items such as due to cracking of the substrate molding material during release, can be suppressed when manufacturing intermediate members. Moreover, releasing between the substrate molding material and the molding die is smooth, so that manufacturing processes proceed more rapidly, and a molding die can be provided which enables an increased amount of production per unit time. Also, intrusion of air bubbles within the substrate molding material is suppressed, so that a molding die can be provided for which the occurrence of flawed items in substrate manufacturing can be further suppressed. And, a molding die can be provided for which, when molding the substrate molding material, air does not readily intrude between the substrate molding material and the molding die, and the occurrence of flawed items due to intrusion of air bubbles into the completed substrate is suppressed.

Further, by means of an intermediate member of this invention, upon release there is thermal contraction in a direction having a component in the direction of release of the intermediate member from the molding die; moreover, even when the amount of thermal contraction in the cooling process is small, release action is easily obtained over the entire molding surface of the molding die, so that the intermediate member is easily released from the molding die. Hence adhesion of the substrate molding material to the molding die in manufacturing processes, and the occurrence of flawed items such as due to cracking of the substrate molding material during release, can be suppressed. Moreover, releasing between the substrate molding material and the molding die is smooth, so that manufacturing processes proceed more rapidly, and an increased amount of production per unit time is possible. Also, intrusion of air bubbles within the substrate molding material is suppressed when molding the substrate molding material to manufacture an intermediate member, so that the occurrence of flawed items in substrate manufacturing can be suppressed. By this means, the occurrence of flawed items during substrate manufacture can be further suppressed.

Further, by means of a method of substrate manufacture of this invention, upon release there is thermal contraction in a direction having a component in the direction of release of the intermediate member from the molding die, and even when the amount of thermal contraction in the cooling process is small, release action is easily obtained over the entire molding surface of the molding die, so that the intermediate member is easily released from the molding die. Hence adhesion of the substrate molding material to the molding die in manufacturing processes, and the occurrence of flawed items such as due to cracking of the substrate molding material during release, can be suppressed. Moreover, releasing between the substrate molding material and the molding die is smooth, so that manufacturing processes proceed more rapidly, and an increased amount of production per unit time is possible. Also, intrusion of air bubbles within the substrate molding material is suppressed, so that the occurrence of flawed items in substrate manufacturing can be suppressed. And, when molding the substrate molding material, air does not readily intrude between the substrate molding material and the molding die, so that the occurrence of flawed items due to intrusion of air bubbles into completed substrates is suppressed.

### BRIEF DESCRIPTION OF THE DRAWINGS

FIG. 1A is a cross-sectional view of a molding die in an embodiment of the invention;

FIG. 1B is a plane view of the molding die of FIG. 1A;

FIG. 2 is an enlarged cross-sectional view of principal portions of a molding die in an embodiment of the invention;

FIG. 3A is a cross-sectional view of a molding die and glass material, when the glass material is placed on the molding die in an embodiment of the invention;

FIG. 3B is a cross-sectional view of a molding die and glass material, when the glass material is being press-molded in the method of the invention;

FIG. 3C is a side view of an intermediate member manufactured as a result of pressing;

FIG. 4A is a cross-sectional view of an intermediate member and an inner-diameter machining core drill when removing the removal area from the intermediate member in an embodiment of the invention;

FIG. 4B is a cross-sectional view of the intermediate member of FIG. 4A with the removal area removed;

FIG. 4C is a cross-sectional view of the intermediate member of FIG. 4 B and an outer-diameter machining core drill when removing an outer-periphery portion from the intermediate member;

FIG. 5A is a cross-sectional view of a substrate in an embodiment of the invention;

FIG. 5B is a plane view of the substrate of FIG. 5A;

FIG. 6A is a cross-sectional view of a concave portion in comparison example 2 which is not in accordance with the present invention; and

FIG. 6B is a cross-sectional view of a concave portion in comparison example 3 which is not in accordance with the present invention.

### DETAILED DESCRIPTION OF THE INVENTION

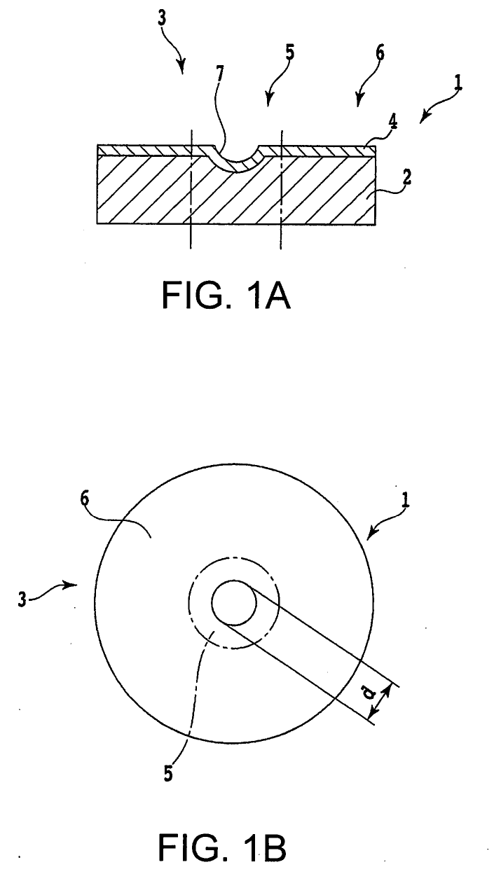

Below, an embodiment of the invention is explained in detail, referring to FIG. 1 through FIG. 5. FIG. 1 shows a molding die 1 for press molding which is used in the manufacture of substrates of the present embodiment and in which FIG. 1A is a cross-sectional view of the molding die 1, and FIG. 1B is a plane view of the molding die 1. In FIG. 1, only the lower-side molding die 1 is shown; in actual implementation, another molding die configured similarly is also used, and the two are used as a pair of molding dies 1. That is, in actuality the molding die 1 has opposing halves which mate to form a cavity having a shape of an object to be molded.

The molding die 1 of this embodiment is configured with the molding surface 3 of the die parent material 2 covered by a protective film 4. In the molding die 1 of FIG. 1A, the entire surface on the upper side, which is the molding-side surface, is formed as the molding surface 3. In the molding surface 3, a removal area molding portion 5 which molds the removal area of the intermediate member explained below is formed in the center portion, and on the outer periphery thereof is formed a disk area molding portion 6 to mold the disk area, which is donut-shaped after the removal area is removed. In FIG. 1A and FIG. 1B, the border between the removal area molding portion 5 and the disk area molding portion 6 is indicated by a dot-dash line. In this embodiment, the removal area molding portion 5 comprises a concave portion 7 which is one portion of a spherical surface. It is preferable that the concave portion 7 be formed from a portion of a spherical surface. However, in this embodiment the concave portion 7 may be a curved surface of another shape, so long as the surface is a continuously concave curved surface portion. As the overall shape, it is sufficient that a concave portion be formed, and that the concave portion be formed from a continuously curved surface. Moreover, the number of centers of radii of curvature in the curved surface may be single or plural, and so long as the curved surface is continuous, it may be a higher-order curved surface.

The molding die 1 in this embodiment is for use in manufacturing a substrate, of outer diameter 27.4 mm and thickness 0.4 mm, with an aperture portion of outer diameter 7.0 mm, obtained by press-molding glass as the substrate molding material. The substrate in this embodiment is for example used as the glass substrate in disks used as magnetic disks.

The outer diameter of the molding die 1 must be larger than the outer diameter of the substrate to be manufactured; in this embodiment, the outer diameter of the molding die 1 is 35.0 mm. The thickness of the molding die 1 must be such that there is sufficient strength to withstand press molding; in this embodiment, the thickness of the molding die 1 is 15.0 mm.

As the die parent material 2 in this embodiment, a super-hard alloy is employed having as a main component tungsten carbide (WC) with cobalt (Co) used as a binder. Hence the thermal expansion coefficient of the die parent material 2 is 47×10⁻⁷/° C. The die parent material 2 is not limited to this material, and may be a super-hard alloy, transition metal alloy, ceramic material, or similar material. As the die parent material 2, a material which can withstand repeated use is desirable.

The protective film 4 in this embodiment comprises platinum (Pt) and is formed to a thickness of approximately 1 μm by a sputtering method. As the material of the protective film 4, it is preferable that the material have sufficient strength to protect the die parent material, have poor wetting properties with glass at high temperatures, and be chemically inert. As materials for the protective film 4, it is preferable that at least one among, or an alloy the main component of which is selected from among, silicon (Si), nickel (Ni), chromium (Cr), titanium (Ti), niobium (Nb), vanadium (V), molybdenum (Mo), platinum (Pt), palladium (Pd), iridium (Ir), rhodium (Rh), osmium (Os), ruthenium (Ru), rhenium (Re), tungsten (W), and tantalum (Ta), as well as at least one type selected from among alumina (Al₂O₃), silicon carbide (SiC), chromium carbide (Cr₃C₂), chromium oxide (Cr₂O₃), silicon nitride (Si₃N₄), and boron nitride (BN), be used. Here, no constraints in particular are placed on the film thickness, so long as the film functions as a protective film. Moreover, no constraints in particular are placed on the film deposition method, so long as the desired material and thickness are obtained. The surface roughness of the molding surface 3 of the molding die 1 differs depending on the substrate surface roughness sought, but a center-line average roughness of 100 nm or less is desirable.

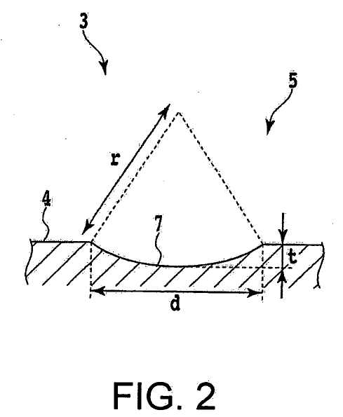

FIG. 2 shows an enlarged cross-sectional view of the vicinity of the concave portion 7 of the removal area molding portion 5 of the molding die 1. In this embodiment, the concave portion 7 is formed as a portion of a spherical surface; the radius of curvature of the spherical surface of the concave portion 7 is shown as r, and the depth of the concave portion 7 is shown as t. The outer diameter d of the concave portion 7 in the removal area molding portion 5 of the molding die 1 must be smaller than the diameter of the aperture portion of the substrate. Hence, in this embodiment, the outer diameter d of the concave portion 7 is set to approximately 4.36 mm, smaller than the aperture portion of the substrate, which is 7.00 mm. The radius of curvature r of the spherical surface is set to 5 mm, and the depth t of the concave portion 7 is set to 0.5 mm.

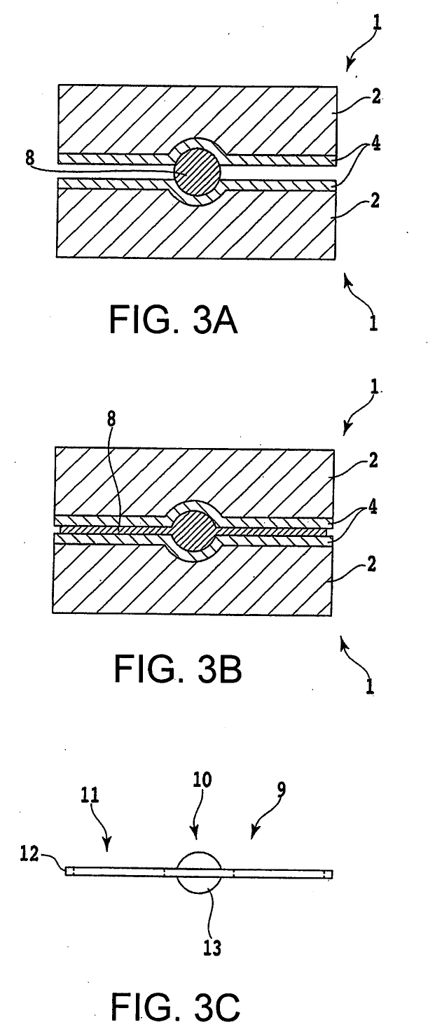

Next, a method of substrate manufacture using the molding die 1 is explained, referring to FIG. 3. FIG. 3A is a cross-sectional view of the molding dies 1 and glass material 8, when the glass material 8, which is the substrate molding material formed into a sphere, is positioned between the pair of molding dies 1. FIG. 3B is a cross-sectional view of the molding die 1 and glass material 8 when the glass material 8 is press-molded by the pair of molding dies 1. FIG. 3C is a side view of the intermediate member 9 manufactured by press-molding of the glass material 8 by the pair of molding dies 1. Here, the intermediate member 9 is an unfinished substrate manufactured in an intermediate stage of substrate manufacture, having a removal area 10 which in a later process is to be removed to become an aperture portion, and a disk area 11 formed as the substrate on the outer periphery of the removal area 10. In addition, there is an outer periphery area 12, which is a portion outside the outer diameter of the substrate to be manufactured, and which is an area to be removed after molding.

As a press-molding process, for example, the glass material 8 is positioned between the molding surfaces 3 of the pair of opposing molding dies 1, as shown in FIG. 3A. Each die of the pair of opposing dies 1 has a disk area molding portion 6 which has a disk shape and a removal area molding portion 5 which comprises a curved surface portion which is continuously concave. In this embodiment, the substrate molding material used is a glass material 8 comprising an alumino-silicate glass, with a softening-point temperature of 625° C., and a thermal expansion coefficient of 82×10⁻⁷/° C., which is larger than the thermal expansion coefficient of the dies 1. In this embodiment, the glass material 8 is heated to 600° C., in the vicinity of the softening point. As explained below, the thermal expansion coefficient of the glass material 8 must be larger than the thermal expansion coefficient of the material of the dies 1. At this time, the glass material 8 put into place is formed into a spherical shape, and it is desirable that the radius of the glass material 8 be formed to be smaller than the radius of curvature r of the spherical surface of the concave portion 7. In this embodiment, the glass material 8 is a sphere of radius 4 mm, which is smaller than the radius of curvature r of the concave portion 7 which is 5 mm. Then, the pair of upper and lower molding dies 1 are heated to a prescribed temperature in the vicinity of the softening point of the substrate molding material.

When the glass material 8 reaches the prescribed temperature, by applying a prescribed pressure to the pair of molding dies 1, press molding is performed as shown in FIG. 3B until the glass material 8 assumes the prescribed shape. In this embodiment, press molding is performed at 450 kgf/cm² until the thickness of the glass material 8 at the outer peripheral portion is 0.4 mm.

Then, in the next process, the molding dies 1 are cooled. At this time, the glass material 8 is cooled slowly, in order that glass breakage does not occur in the process of cooling and solidification of the glass material 8. Then, through cooling of the molding dies 1 and glass material 8, thermal contraction of the molding dies 1 and glass material 8 occurs. In the cooling process, because the thermal expansion coefficient is larger for the glass material 8 than for the molding dies 1, even when the same temperature change occurs, the contraction of the glass material 8 is larger compared with that of the molding dies 1 due to the difference in thermal expansion coefficients. At this time, the outer periphery of the glass material 8 with large thermal contraction contracts in the direction parallel to the molding surfaces 3 of the molding dies 1 accompanying thermal contraction, and as a consequence is released from the molding dies 1. On the other hand, a convex portion corresponding to the concave portion of the molding dies 1 is provided in the center of the glass material 8 and, moreover, by forming this convex portion as a spherical surface, contraction occurs in central directions of the spherical surface, that is, in directions moving away from the molding surface 3. By this means, release from the molding dies 1 is easily achieved through thermal contraction of the glass material 8 itself. In this embodiment, after performing slow cooling of the glass material 8 until approximately 200° C., the glass material 8 is caused to be released from and is removed from the molding dies 1.

In the molding dies 1 of this embodiment, a concave portion 7 is formed on the molding surfaces 3 of the molding dies 1 so that release is easily performed in the center portion at which release has been difficult in the prior art, and the glass material 8 can easily be removed. By this means, adhesion of the substrate molding material to the molding dies in manufacturing processes, and cracking of the substrate molding material upon release, as well as other occurrences of flaws in molded items can be suppressed. Moreover, releasing between the glass material 8 and the molding die 1 is smooth, so that manufacturing processes proceed more rapidly, and an increased amount of production per unit time is possible. Also, intrusion of air as air bubbles within the glass material is suppressed, so that the occurrence of flawed items in substrate manufacturing can be suppressed.

After release of the glass material 8, the glass material 8 is completely solidified by cooling, and becomes the intermediate member 9. In the intermediate member 9 are formed a removal area 10 and, on the outer periphery of the removal area 10, a disk area 11. In the removal area 10, a convex portion 13 is formed by the concave portion 7 of the molding dies 1 in the center portion of the removal area 10. In this embodiment, the convex portion 13 is formed as a portion of a spherical surface. However, the shape of the convex portion 13 is not limited to such a shape, and may be a curved surface of another shape, so long as it is a curved surface portion which is continuously convex corresponding to the shape of the concave portion 7. As the overall shape, a convex shape is formed the convex portion of which is continuous and formed from a curved surface. Moreover, there may be a plurality of centers of curvature in the curved surface rather than only one, and if the curved surface is continuous, it may be a higher-order curved surface.

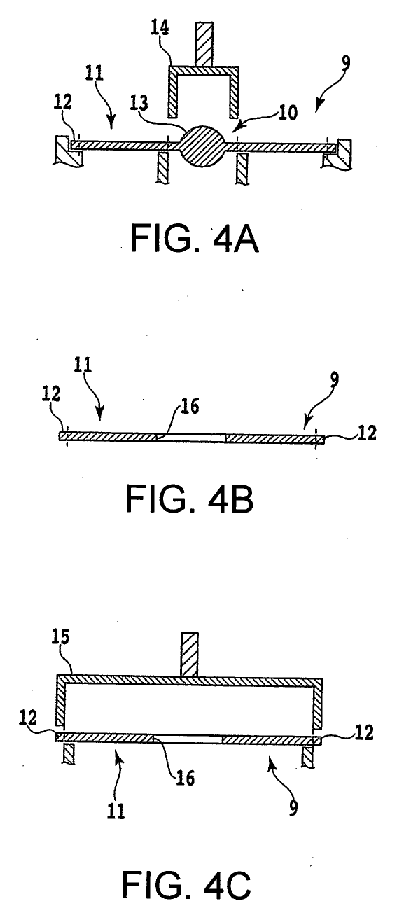

The removal area 10 and outer peripheral area 12 are removed from the intermediate member 9 to manufacture the substrate. The processes of removing the removal area 10 and outer peripheral area 12 from the intermediate member 9 are explained in the following with reference to FIG. 4A through FIG. 4C.

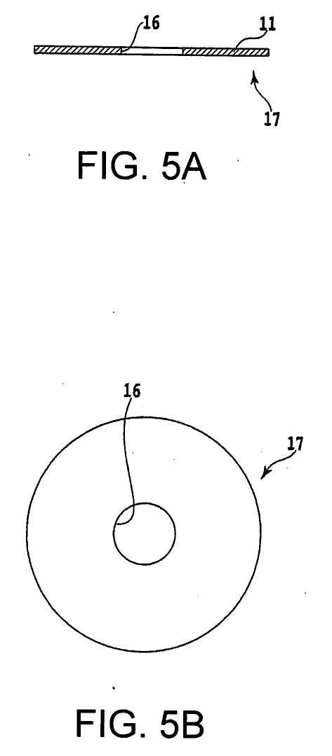

As shown in FIG. 4A, the removal area 10 is removed from the intermediate member 9 by punch-out machining using an inner-diameter machining core drill 14. A diamond abrasive wheel is used as the cutting edge of the inner-diameter machining drill 14. This inner-diameter machining core drill 14 is positioned opposite a prescribed position of the intermediate member 9, and by then lowering the inner-diameter machining core drill 14, the removal area 10 is punched out. As a result, as shown in FIG. 4B, the removal area 10 is removed from the intermediate member 9, to form an intermediate member 9 in which only the disk area 11 and outer peripheral area 12 remain. By removing the removal area 10 from the intermediate member 9, an aperture portion 16 is formed in the intermediate member 9. Then, as the next process, the outer-diameter machining core drill 15 is used to remove the outer peripheral area 12 from the intermediate member 9, in which only the disk area 11 and outer peripheral area 12 remain, by punch-out machining as shown in FIG. 4C. The outer-diameter machining drill 15 also uses a diamond abrasive wheel as the cutting edge. On the occasion of punch-out machining of the outer peripheral area 12 also, the outer-diameter machining core drill 15 is opposed to a prescribed position of the intermediate member 9, and by then lowering the outer-diameter machining core drill 15, the outer peripheral area 12 is punched out. When the outer peripheral area 12 is removed from the intermediate member 9, the substrate 17 is formed as shown in FIG. 5A and FIG. 5B. In the substrate 17, an aperture portion 16 corresponding to the removal area 10 is formed by removing the removal portion 10. In this way, the removal area 10 and outer peripheral area 12 are removed from the intermediate member 9 to manufacture the substrate 17. The order of machining when punching-out the removal area 10 and outer peripheral area 12 from the intermediate member 9 is not limited to the order of this embodiment, and either member may be removed first.

Next, the above embodiment is studied in comparison with comparison examples.

As comparison example 1, a case is explained of a molding die with planar molding surfaces 3, with no concave portions provided in the molding die. Other conditions are similar to those of the above embodiment. In this case, release of the glass material from the molding die was not promoted, and release was not satisfactorily achieved. Comparing the above embodiment with comparison example 1, the above embodiment is clearly superior with respect to release behavior, and has a molding die shape appropriate for substrate manufacture.

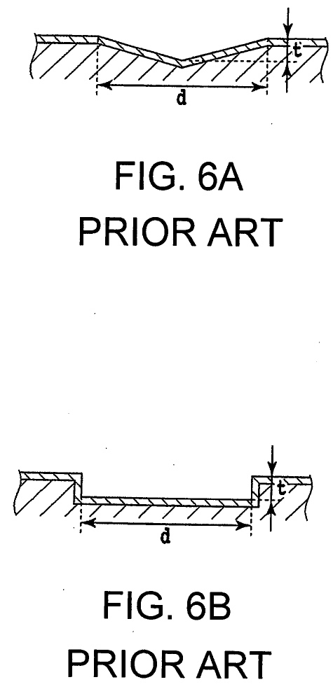

As comparison example 2, a case is explained in which a triangular pyramid-shaped concave portion was formed in the center of the removal area molding portion of the molding die. FIG. 6A is a cross-sectional view of the concave portion in comparison example 2. Here, similarly to the above embodiment, the outer diameter d of the concave portion is 4.36 mm, and the depth t of the concave portion is 0.5 mm. Other conditions are similar to those of the above embodiment. In the case of comparison example 2, a concave portion was provided in the center of the removal area, so that compared with comparison example 1, release was easier; but because the curved surface at the apex of the concave portion formed in a triangular pyramid shape was not continuous, there is a concern that air may intrude between the glass material and the molding die in the vicinity of the apex. Hence, there is a concern that air bubbles may enter into the intermediate member manufactured by molding. However, the location of the flaw occurring as a result is within the removal area of the intermediate member so that, in the process of removing the removal area after molding, it is highly probable that the location is a portion which is removed by the inner-diameter machining core drill. Hence, there is expected to be little effect on the disk surface of the substrate which is the original requirement of the process.

As comparison example 3, a case is explained in which a cylindrical-shape concave portion was formed in the center of the removal area molding portion of the molding die 1. FIG. 6B is a cross-sectional view of the concave portion of comparison example 3. In comparison example 3, the outer diameter d of the concave portion was 4.36 mm, and the depth t of the concave portion was 0.5 mm. In comparison example 3 also, a concave portion was provided in the center of the removal area so that compared with comparison example 1 release is made easy, but there exists a portion of the curved surface which is not continuous in the concave portion formed in a cylindrical shape. Hence, there is a concern that air may intrude between the glass material and the molding die in the vicinity of this portion. However, the location of the flaw occurring as a result is within the removal area of the intermediate member, and in the process of removing the removal area after molding, it is highly probable that the location is a portion which is removed by the inner-diameter machining core drill. Hence, there is expected to be little effect on the smooth surface of the substrate which is the original requirement of the process.

By comparing the above embodiment in which the concave portion 7 is formed with a spherical surface with comparison example 2 and comparison example 3, the effectiveness of providing a concave portion, comprising a continuously curved surface, in the center of the removal area of the molding die can be understood. In particular, the desirability of using a spherical surface as the continuously curved surface can be understood.

As comparison example 4, a case is explained in which a concave portion comprising a spherical surface similar to that of the above embodiment was formed in the center of the removal area molding portion of the molding dies 1, and glass material formed into a cube 4 mm on a side was placed there within. Other conditions were similar to those of the above embodiment. The glass material of cubic shape was placed in the molding die and press-molding performed without further modification. In this case, when performing molding, gaps occurred between the glass material and the molding die. Thus, when molding is performed without further modification, there is concern that flaws in the substrate due to intrusion of air are greater than in comparison examples 2 and 3.

As comparison example 5, a case is explained in which a concave portion comprising a spherical surface was formed in the center of the removal area molding portion of the molding dies 1 and glass material formed into a sphere of radius 5.5 mm was placed there within. In comparison example 5, because the radius of the glass material is increased, the volume of the glass material is increased. Hence, when using a molding die similar to that of the above embodiment, if the thickness of the outer peripheral area of the intermediate member is 0.4 mm, then the outer diameter is approximately 47 mm. Hence, in comparison example 5, a molding die with outer diameter of 50 mm was used. Other conditions were similar to those of the above embodiment. Glass material formed into a sphere of radius 5.5 mm was placed in the molding die and press-molding performed without further modification. In this case, when performing molding, gaps occurred between the glass material and the molding die. Thus, when molding is performed without further modification, there is concern that flaws in the substrate due to intrusion of air are greater than in comparison examples 2 and 3.

As is seen from comparison examples 4 and 5, it is desirable that the glass material in the above embodiment be spherical in shape, and that the radius of the glass material be smaller than the radius of curvature of the concave portion, and smaller than the outer diameter d of the concave portion.

As comparison example 6, a case is explained in which the glass material was a sphere of radius 4 mm, comprising a borosilicate glass with softening temperature 820° C. and thermal expansion coefficient 33×10⁻⁷/° C. In comparison example 6, after heating to 800° C., press molding was performed at 450 kgf/cm² until the press-molded glass plate 6 had a thickness of 0.4 mm. Then, after slow cooling to approximately 200° C., the glass material was released from the molding die and removed. In comparison example 6, the thermal expansion coefficient of the glass material is smaller than the thermal expansion coefficient of the molding die. Hence, in the process of cooling after press-molding of the glass material, the contraction of the molding die is greater than that of the glass material during thermal contraction. As a result, thermal contraction causes the glass material to adhere to the molding die so that release becomes extremely difficult. Hence, from comparison example 6 the usefulness of a thermal expansion coefficient for the glass material which is larger than the thermal expansion coefficient of the molding die can be understood.

In the above embodiment, a case was explained in which glass material 8 was used in press molding; however, this invention is not limited to such cases and materials other than glass materials may be used. Further, so long as molding is performed using a die, the molding need not be press molding. Moreover, in this embodiment the substrate 17 was explained as a glass substrate for disks used in magnetic disks, and the substrate 17 was formed in a disc shape with an aperture portion in the center; however, this invention is not limited to such substrates, and the shape of the substrate need not be a disc shape. Further, the aperture portion 16 and the removal area 10 of the intermediate member 9 need not be provided in the center of the substrate.

It is understood that various other modifications will be apparent to and can be readily made by those skilled in the art without departing from the scope and spirit of the present invention. Accordingly, it is not intended that the scope of the claims appended hereto be limited to the description set forth above but rather that the claims be construed as encompassing all of the features of patentable novelty which reside in the present invention, including all features which would be treated as equivalents thereof by those skilled in the art to which the invention pertains.

What is claimed is:

1. A molding die for an intermediate member used to manufacture a substrate having an aperture portion and a disk area, the molding die comprising:
a disk area molding portion which has a disk shape; and
a removal area molding portion which comprises a curved surface portion which is continuously concave,
wherein the intermediate member has a disk area and a removal area,
wherein the disk area molding portion molds the disk area of the intermediate member and the removal area molding portion molds the removal area of the intermediate member, and
wherein the removal area of the intermediate member becomes the aperture portion of the substrate through removal thereof.

2. The molding die according to claim 1, wherein the intermediate member is made of a substrate molding material, wherein the molding die is composed of a material which has a thermal expansion coefficient which is smaller than that of the substrate molding material to facilitate release of the intermediate member from the molding die, and wherein, due to the curved surface portion, the intermediate member undergoes thermal contraction in a direction having a component in the direction of release from the molding die so that uniform release of the intermediate member from the molding die is facilitated

3. The molding die according to claim 2, wherein the substrate molding material is glass.

4. The molding die according to claim 2, wherein, due to the curved surface portion, air does not readily intrude between the molding die and the substrate molding material so that uniformity of the intermediate member is facilitated.

5. The molding die according to claim 1, wherein the molding die has opposing halves which mate to form a cavity and which each have a disk area molding portion which has a disk shape; and a removal area molding portion which comprises a curved surface portion which is continuously concave.

6. An intermediate member used to manufacture a substrate having a disk area and an aperture portion, the intermediate member comprising:
a disk area; and
a removal area which comprises a curved surface portion which is continuously convex and which becomes the aperture portion of the substrate through removal thereof.

7. The intermediate member according to claim 6, wherein the intermediate member is composed of glass.

8. A method of manufacturing a substrate including an aperture portion and a disk area, the method comprising the steps of:
a. providing a molding die for an intermediate member comprised of:
a disk area molding portion which has a disk shape; and
a removal area molding portion which comprises a curved surface portion which is continuously concave,
wherein the intermediate member has a disk area and a removal area,
wherein the disk area molding portion molds the disk area of the intermediate member and the removal area molding portion molds the removal area of the intermediate member, and
wherein the removal area of the intermediate member becomes the aperture portion of the substrate through removal thereof;
b. molding a substrate molding material using the molding die to manufacture the intermediate member; and
c. removing the removal area from the intermediate member to form the aperture portion of the substrate.

9. The method of manufacturing a substrate according to claim 8, wherein the molding die is composed of a material which has a thermal expansion coefficient which is smaller than that of the substrate molding material so that release of the intermediate member from the molding die is facilitated.

10. The method of manufacturing a substrate according to claim 9, wherein the substrate molding material is glass, wherein molding is press molding in which pressure is applied to the substrate molding material, and wherein the method further comprises the steps of heating the glass to a temperature close to its softening point prior to molding; and cooling the intermediate member after molding so that release of the intermediate member from the molding die is facilitated.

11. The method of manufacturing a substrate according to claim 10, wherein, due to the curved surface portion, the intermediate member undergoes thermal contraction during cooling in a direction having a component in the direction of release from the molding die so that uniform release of the intermediate member from the molding die is facilitated.

12. The method of manufacturing a substrate according to claim 8, wherein, due to the curved surface portion, air does not easily intrude between the molding die and the substrate molding material so that uniformity of the intermediate member is facilitated.

13. The method of manufacturing a substrate according to claim 8, wherein molding further comprises introducing the substrate molding material into the molding die as a material having a shape with a radius of curvature which is smaller than that of the concave surface portion of the molding die so that air does not readily intrude between the molding die and the substrate molding material and so that uniformity of the intermediate member is facilitated.
